(19) United States
(12) Patent Application Publication
(10) Pub. No.: US 2005/0256738 A1
(43) Pub. Date: Nov. 17, 2005

(54) Methods and systems for identifying health care professionals with a prescribed attribute

(76) Inventor: Harold J. Petrimoulx, Phoenixville, PA (US)

Correspondence Address: Law Offices of Grady White, Suite 300, 7272 Wisconsin Avenue, Bethesda, MD, 20814, US

(21) Appl. No.: 11/046,174

(22) Filed: Jan. 28, 2005

Related U.S. Application Data
(60) Provisional application No. 60/569,832, filed on May 11, 2004.

(51) Int. Cl. G06F 17/60

(52) U.S. Cl. 705/2

(57) ABSTRACT

Systems and methods for identifying health care professionals or physicians having certain prescribed attributes can be employed to identify health care professional or physician influence networks for the purpose of improving the efficiency and effectiveness of a pharmaceutical company's sales force. Such identified physicians can include, for example, influencer physicians, influenced, and high prescribing physicians. The method for identifying such physicians involves the use of a mathematical methodology to analyze surveys to determine the size of a physician population and the influencers therein.

### RELATED APPLICATION

This application claims the benefit of U.S. Provisional Application No. 60/569,832, filed May 11, 2004, which is incorporated by reference herein in its entirety.

### FIELD OF THE INVENTION

This invention relates generally to methods and systems for identifying health care professionals or physicians with certain prescribed attributes within a health care professional or physician population. For example, the invention described herein can be employed to identify physician-influence networks for the purpose of improving the efficiency and effectiveness of a pharmaceutical company's field sales force.

### BACKGROUND OF THE INVENTION

In today's health care market, physicians are highly time pressured and encouraged to see as many patients as possible, which in turn reduces the amount of time physicians have to meet with pharmaceutical sales representatives. This presents a challenge to the pharmaceutical industry, since the most effective way to sell prescription pharmaceuticals is by directly marketing to the physician (as opposed to marketing directly to consumers). As described below, the present invention provides a novel system for identifying “physician influence networks” that can be used to more effectively market prescription pharmaceuticals and the like. Accordingly, to provide a more thorough description of the present invention, we will now provide further background information about pharmaceutical sales approaches and the apparently unrelated field of wildlife surveying.

The Marketing of Pharmaceuticals

Over the past decade, the number of sales representatives in the pharmaceutical industry has tripled to 90,000. The reason driving this growth is that face-to-face sales to physicians are more effective than consumer advertising at increasing drug prescriptions—and enhancing drug sales. NDCHealth estimates that drug companies spent about $7.2 billion on their sales forces in 2001, more than 2.5 times as much as they spent on consumer advertising. The Wall Street Journal 241:115, 2003.

The explosion of pharmaceutical sales forces means that pharmaceutical companies now send out overlapping sales representatives to cover the same territory, promote the same drugs and visit physicians almost weekly. The numbers of sales persons increasingly compete for physicians' time when they are also seeing more patients than ever because of rising health care costs and reduced medical benefits.

Furthermore, over the past decade, “peer promotion” (or peer influence) has joined direct mail, journal advertising, and sales representatives as a method of promoting products to physicians. In a carefully guided discussion, the highly regarded physicians often influence their peers. Peer promotion as a marketing tool began sometime in the mid-1980s—a clear offshoot of market research focus groups. It was found that with the proper mix of physicians, the enthusiasm of well respected prescribers of a product could have a significant impact on low- to moderate prescribing physicians or those who had yet to try the product. Pharmaceutical companies began their peer promotion efforts by recruiting and training marketing consultants and managers who were committed to conducting peer influence groups throughout the nation. Medical Marketing & Media, CPS Communications, Inc., October 1997. The more common, current practice involves specially trained sales representatives that recruit well respected physicians to speak on behalf of a product that they have used extensively with positive result. Most major companies in the pharmaceutical industry are wrestling with how to move beyond the currently unsustainable escalation in sale force size. Leveraging peer influence groups represents an opportunity to provide effective promotion without adding more sales representatives. To identify peer promotion or peer influence, the physician population has been queried and surveyed. PCT International Application WO 2001/016839; U.S. application No. 20030216942. However, a need exists in the art for a methodology to accurately determine the number of peer influencers within a physician population.

As described in greater detail below, one aspect of the present invention concerns the application of certain surveying solutions and methodologies to the problem of identifying influential physicians and their peer influence group of physicians and further to the problem of identifying influential physicians in a geographical area that are influential, socially and professionally to other physicians. Several companies have already deployed handheld devices to their field sales force (FSF) that possess the capability of rapidly processing survey information from a physician population.

Population Size Estimate by “Mark and Recapture” Methods

Statistical methods have been developed in the unrelated field of wildlife biology to estimate populations of animals. Marking of fish or other animals has been used to compute the rate of exploitation of the population, and to compute the total population of animals living in either a closed or open population. The methods of population estimation are commonly referred to as “mark and recapture.” See Krebs, Ecology, Harper and Row, N.Y., 1972; Krebs Ecological Methodology, Benjamin/Cummings, Menlo Park, Calif., 1999; Ricker, Bull. Fish. Res. Board Can. 191:382, 1975; http://www.fw.umn.edu/FW5601/alab/lab8/mr_schu.htm.

Population size estimate by the Petersen method: The Petersen method (Ricker, 1975) is a mark-recapture method for estimating population size, N₀. For the Petersen method, all animals in a single sample are given a mark or tag and returned to the environment alive. The number of animals receiving the mark and successfully returned alive to the environment is M. At a subsequent time, a single sample is taken and all animals are examined for the mark. In this recapture sample, a total of C animals were captured and R were found to have the mark.

If one argues that the proportion of animals in the recapture sample that had the mark (i.e., R/C) is the same as the proportion of animals in the population that had the mark (i.e., M/N₀) then one can set the ratios equal,

$$\frac{M}{{N}_{0}} = \frac{R}{C}$$

and solve for N₀, namely

$${N}_{0} = \frac{MC}{R} \qquad ( eqn 1 )$$

or sometimes it is instructive to write it as

$${N}_{0} = \frac{M}{\frac{R}{C}} \qquad ( eqn 1 a )$$

Thus, to estimate the population size before marking the animals, N₀, one multiplies the number marked (M) by the total number in the recapture sample (C) and divides by the number of animals in the recapture sample that had the mark (R). Intuitively, equation 1 a states that the population size is equal to the number of animals marked divided by the estimate of the proportion that are marked.

However, equation 1 tends to overestimate N₀. Seber (Ricker, 1975) suggests that

$${N}_{0} = \frac{( M + 1 ) ( C + 1 )}{( R + 1 )} - 1 \qquad ( eqn 2 )$$

is an unbiased estimate of N₀ when (M+C)≧N₀ and nearly unbiased when R>7.

Confidence Intervals: As with all estimates, one must provide an estimate of the variability (precision) of the estimate. There are several methods for obtaining confidence intervals (CIs) for N₀ in the Petersen method. Seber offers the following guide:
If R/C<0.10 and r<50 then use Poisson CIs
If R/C<0.10 and r>50 then use Normal approximation CIs
If R/C>0.10 then use Binomial CIs

Poisson CIs treat R as a random variable and ask how much variation one might expect to see in R in a series of random samples from a Poisson distribution (Ricker, 1975). The confidence intervals for N₀ are found by finding the row in a table for Poisson CIs that corresponds to the observed R in the recapture sample. The lower and upper 95% values for R are then read from the table. The lower and upper bound for R are put into equation 1 or 2 to find the upper and lower 95% bounds for N₀.

Normal approximation CIs find a CI for the ratio R/C (or (R+1)/(C+1)) with

$$\frac{R}{C} \pm [ \frac{1}{2 C} + {z}_{α} \sqrt{\frac{( 1 - \frac{R}{M} ) ( \frac{R}{C} ) ( 1 - \frac{R}{C} )}{C - 1}} ] \qquad ( eqn 3 )$$

where Z_{α} is the z-value for a (1−α)100% confidence. The lower and upper bound for N₀ is found by substituting the lower and upper bound for R/C into equation 1 or 2.

Binomial CIs are most easily computed from graphs (e.g., Krebs' FIG. 2.2). One can use these figures to find a lower and upper bound for R/C (or (R+1)/(C+1)). These bounds are then entered into equation 1 to find the upper and lower bounds of N₀. In computing confidence intervals for equation 2, one can compute the CIs for (R+1)/(C+1) instead of R/C.

Population size estimate by the Schnabel method: The Schnabel method (Ricker, 1975) extends the Petersen method to more than 1 resample. The theory is exactly the same—N₀ is estimated by the ratio of the number of marked animals released into the population to the estimated proportion of marks in the population. The Schnabel estimate of N₀ is a weighted average of s, the number of individual Petersen estimates, namely

$${N}_{0} = \frac{{\sum }_{t = 1}^{1} ( {C}_{t} {M}_{t} )}{{\sum }_{t = 1}^{1} {R}_{t}} \qquad ( eqn 6 )$$

where Mₜ is the number of marked animals in the population just before the sample at time t is taken, Cₜ is the number of animals in the sample at time t, and Rₜ is the number of animals in the sample at time t that had a mark. Krebs (1989) states that, if Cₜ/N₀ and Mₜ/N₀ are always less than 0.1, a better estimate is

$${N}_{0} = \frac{{\sum }_{t = 1}^{1} ( {C}_{t} {M}_{t} )}{1 + {\sum }_{t = 1}^{1} {R}_{t}} \qquad ( eqn 7 )$$

The standard error of the inverse of N₀ is

$${SE}_{{N}_{0}} = \sqrt{\frac{{\sum }_{i = 1}^{s} {R}_{t}}{{( {\sum }_{i = 1}^{s} {C}_{t} {M}_{t} )}^{2}}} \qquad ( eqn 8 )$$

One can use this formula to compute the lower and upper 95% CI bound for 1/N₀(df=s−1) and then compute the inverse of each of these to get the lower and upper bound for N₀.

To accurately estimate N₀ with the Petersen or Schnabel methods, these five assumptions should be met:
1. The population is closed.
2. All animals have the same chance of being caught in a sample (i.e., must be a random sample).
3. Marking animals does not affect their ability to be recaptured.
4. Animals do not lose marks between the two sampling periods.
5. All marks are reported on discovery of marked animals in the second sample.

A need exists in the art for improved methods for identifying physician influence networks. Identification of physician influence networks can be achieved through a series (waves) of simple questionnaires that solicit data from targeted physicians/customers as to who they rely on for trusted information. The challenge is that the survey response rates are relatively low, requiring several waves of surveys. Further, the survey methodologies, generally, have not provided effective methods to calculate the number of influencers estimated to exist in the population. These estimates of the expected numbers of influencers are needed to provide a guide as to when surveying should cease once a desired percentage of influencers have been identified and a point of diminishing return has been reached. A need exists in the art for a cost effective and accurate method to identify physicians that are influential with their peers and physicians that prescribe higher volumes of a pharmaceutical within a physician population.

### SUMMARY OF THE INVENTION

To identify health care professionals with a prescribed attribute within a health care professional population, the health care professional population is surveyed in one or more waves of surveys, and calculations are performed to determine a proportion of the population with certain prescribed attributes. In one embodiment, a method comprises surveying a health care professional population and obtaining responses from the health care professional population, identifying health care professionals with a prescribed attribute using results of the survey, and analyzing the identified health care professionals with the prescribed attribute using a population marking methodology to determine size of a population having the prescribed attribute with a predetermined level of precision.

In another embodiment, a method comprises surveying a physician population and obtaining responses from the physician population, identifying physicians with a prescribed attribute using results of the survey, and analyzing the identified physicians with the prescribed attribute using a population marking methodology to determine size of a population having the prescribed attribute with a predetermined level of precision. A “prescribed attribute,” as this term is used herein, can include, e.g., influencer, meaning that the physician with this attribute has been identified as someone of high professional/social standing in the medical community wherein other physicians desire to mimic the characteristic and desire to attain the status. The physician with a prescribed attribute influences his or her physician-colleagues in their decisions as to which drugs to prescribe in a given situation. Similarly, an attribute can be attributed to those physicians that are influenced by others, or that are high prescribers or low or moderate prescribers. The physician with a prescribed attribute can also be, for example, a physician who influences managed care formularies or a physician who has an interest in participating in clinical drug research. The present invention is by no means limited to the specific type of target attributes.

The inventive method for identifying physicians with certain prescribed attributes can further be characterized as surveying the physician population in a second survey, and analyzing second survey responses. This method can be repeated as described below until the estimate of the number of physicians with the prescribed attribute achieves a predetermined level of statistical precision.

Other aspects of the present invention are described below.

### BRIEF DESCRIPTION OF THE DRAWINGS

FIG. 1 shows a graphic representation of the identification of a physician influence network utilizing multiple waves of surveys of a physician population. A physician influence network within a physician population can be viewed as a network of interconnected hubs and spokes. The hubs are the “influencer” physicians, and the “influenced” physicians are at the end or junction of the spokes. Each hub can have one or more spokes emanating from it. Each spoke end or junction can conceivably connect to one or more hubs.

FIG. 2 shows a flow chart of the decision-making process in surveying a physician population to identify physicians with a prescribed attribute. A system comprises a distributed computing survey of targeted physician/customers which is collected and processed on a computing device, e.g., a personal digital assistant (PDA) of a pharmaceutical sales representative.

FIG. 3 shows a flow chart of the decision-making process in surveying a physician population to identify physicians with a prescribed attribute. A system comprises a distributed survey of targeted physician/customers that can be an oral or written survey or a mail survey. The distributed survey is collected, and the responses are then tabulated. The survey can be tabulated and processed on paper, or on a computing device, e.g., a personal digital assistant (PDA) of a pharmaceutical sales representative or on a centralized computer server.

### DETAILED DESCRIPTION OF ILLUSTRATIVE EMBODIMENTS

Overview

To identify physicians with a prescribed attribute within a physician population, the physician population is surveyed in one or more waves of surveys, and calculations are performed to determine a proportion of the population with specific attributes (e.g., physician influencers or physicians who are influenced). Once the wave of surveys finds physician influencers or physicians who are influenced that have been previously identified in prior survey waves, one can estimate the size of the influencer population, and one can estimate the confidence interval around the estimate. With each successive survey wave a more refined estimate can be developed. The multiple waves of surveys are analyzed using the methodology of the present invention. As the estimate and confidence interval begin to asymptotically converge to some pre-determined level of consistency and precision, the sampling can then be halted to maximize benefit versus cost.

A method and system for identifying physicians with a prescribed attribute is described below. In one embodiment, a method comprises surveying a physician population and obtaining responses from the physician population, identifying physicians with a prescribed attribute using results of the survey, and analyzing the identified physicians with the prescribed attribute using the methodology of the present invention to identify and estimate the number of physicians with a prescribed attribute, and to determine size of a population having the prescribed attribute with a predetermined level of precision. To identify physician with a prescribed attribute within a physician population, the physician population is surveyed, survey responses of physicians within the physician population are analyzed using a population marking methodology, and physicians with a prescribed attribute within the physician population are estimated. The method further comprises surveying the physician population in a second survey, analyzing second survey responses of physicians within the physician population using the methodology, identifying the physicians with a prescribed attribute, and comparing the initial survey responses and the second survey responses to determine newly-identified physicians with a prescribed attribute and previously-identified physicians with a prescribed attribute. The method further provides surveying the physician population and analyzing and comparing survey responses additional times until the estimate of the number of physicians with a prescribed attribute achieves a predetermined level of statistical precision.

Physician Influence Network

In one embodiment, the method for identifying physicians with a prescribed attribute within a physician population is useful to identify physician influence networks. These networks identify physicians that influence the prescribing practices of other physicians either because the physician influencers are recognized experts or trusted friends. The method identifies physician influencers, ones who influence decision making in the areas of medical care and prescription of pharmaceutical drugs and biologics, and also identifies physicians who are influenced by others in making decisions in the areas of medical care and prescription of pharmaceutical drugs and biologics.

The survey questionnaire can ask a series of questions related to: (1) Who do you look to for therapeutic guidance as a medical expert? (2) Who do you look to for counsel on a case study basis as a trusted friend? (3) Do you prescribe a particular pharmaceutical drug and how often?

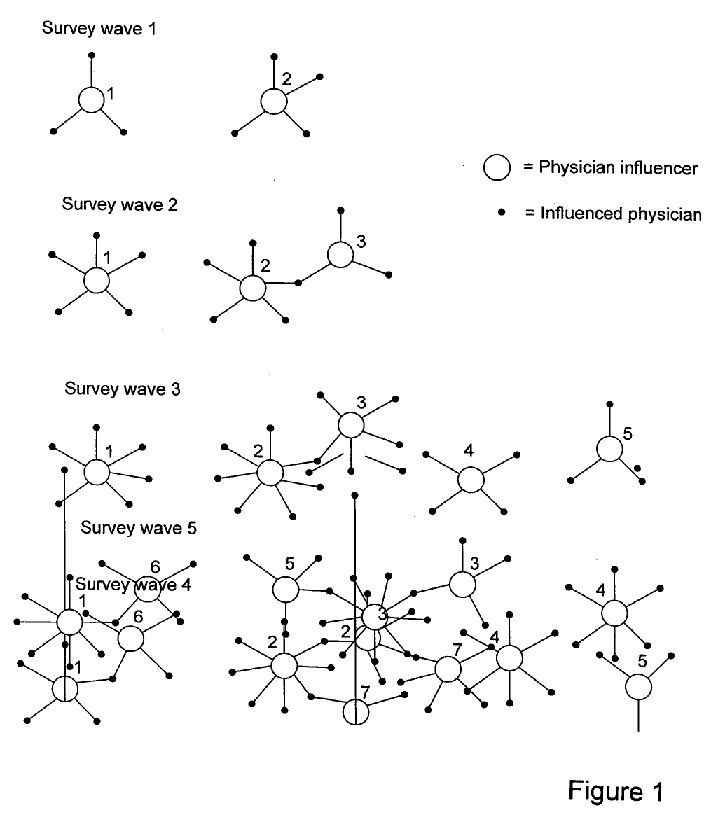

As shown in FIG. 1, a physician influence network within a physician population can be visualized as a series of interconnected hubs and spokes that are identified by multiple waves of surveys of the physician population. A hub represents a physician influencer, and an end of a spoke or a junction of two spokes represents a physician who is influenced. Each hub can have one or more spokes emanating from it. Each spoke can conceivably connect to one or more hubs. The physician influencer can influence the medical decision-making and medical practice of an influenced physician. The physician influencer can influence the pharmaceutical prescribing practices of an influenced physician.

In a further detailed embodiment, national level physician influencers can influence local area physician influencers. A national level physician influencer is a physician who influences other physicians throughout the United States and in countries outside the United States by virtue of the fact that the physician is recognized nationally, for example, as one who publishes in journals with national or worldwide distribution (peer-reviewed or non peer-reviewed publications); physicians who speak or lecture nationally, or are recognized by the media (television, radio, newspaper, or magazine) as an expert in the field. A local area physician influencer is a physician who influences other physicians within a smaller geographic area, for example, state, metropolitan area, region, or neighborhood, or one who is influential within a local physician community or local hospital or clinic setting or by local media or local publications. National level physician influencers or local area physician influencers can be identified by geographic region, socioeconomic region, or within a similar medical specialty or practice which comprise similar patient populations and similar prescribing patterns for a pharmaceutical drug. Identifying national level physician influencers and local area physician influencers can benefit a pharmaceutical company by expanding and targeting a network of influencers to further increase dissemination of information from physician influencers to physicians who are influenced.

In another embodiment, a method comprises (a) surveying a health care professional population and obtaining responses from the health care professional population, (b) identifying health care professionals with a prescribed attribute using results of the survey, and (c) analyzing the identified health care professionals with the prescribed attribute using a population marking methodology to determine size of a population having the prescribed attribute with a predetermined level of precision. Steps a, b, and c can be repeated until a predetermined level of statistical precision is achieved in estimating the size of the population having the prescribed attribute. Furthermore, the repeated surveying steps can comprise surveying a new or non-respondent health care professional population. In a further embodiment, the method comprises enumerating the number of health care professionals who possess the prescribed attribute.

In a further detailed aspect, surveying the health care professional population further comprises asking respondents to identify health care professionals who influence their health care decision-making. Surveying further comprises asking respondents to identify health care professionals who influence their medical decision-making regarding recommendation of prescription drugs or treatments, non-prescription drugs or treatments, or therapeutic procedures. In a detailed aspect, health care professionals with the prescribed attribute are a source of therapeutic guidance as experts in their health care field.

In a further detailed embodiment, health care professionals with the prescribed attribute are health care professionals who influence others. The health care professionals with the prescribed attribute are a source of trusted information. In a detailed aspect, the health care professional is a medical doctor, osteopathic doctor, nurse, physician's assistant, physical therapist, or pharmacist.

A “physician who influences others” within the physician population (physician influencer) refers to one or more physicians who influence other physicians in their medical decision-making related to methods of medical treatment, or decisions related to prescribing pharmaceutical drugs and biologics. The physician influencer can have expertise in a particular area of medicine, or can have a number of years of experience in medical practice, or can have had particular success in using a particular pharmaceutical drug or biologic in treating patients. One who is influenced by others within the physician population (influenced physician) refers to one or more physicians who are influenced by other physicians in their medical decision-making related to methods of medical treatment, or decisions related to prescribing pharmaceutical drugs and biologics.

The physician influence network is identified through a series (waves) of questionnaires that solicit information/data from targeted physicians/customers as to whom they rely on for trusted information. For example in FIG. 1, after survey wave 1, two physician influencers were identified by seven influenced physicians. Three physicians identified one physician as influential in their decision-making, and four physicians identified a second physician as influential in their decision making. After survey wave 2, a third physician influencer was identified. Three physicians identified the third physician influencer. One physician identified the second and third physicians as influential in their decision-making. After survey wave 3, fourth and fifth physician influencers were identified by four physicians and three physicians, respectively, as influential in their decision-making. Five additional physician identified the first, second, and third physician influencers. After survey wave 4, sixth and seventh physician influencers were identified. An influenced physician that identified the sixth physician influencer also identified the first physician influencer. An influenced physician that identified the seventh physician influencer also identified the second physician influencer. After survey wave 5, an influenced physician that had previously identified the fifth physician influencer also identified the second physician influencer. The waves of survey continue until the number of physicians with a prescribed attribute (influenced or influencing physicians) achieves a predetermined level of statistical precision.

“Physician population” refers to a set of individual physicians from which a statistical sample is taken. The set of individual physicians can be within a geographic region, a socioeconomic region, or within a similar medical specialty or practice which comprise similar patient populations and similar prescribing patterns for a pharmaceutical drug.

“Customer” or “targeted physician” refers to a physician or other health care professional, e.g., physician assistant, nurse, or pharmacist, who is influenced by a physician influencer in their professional practice, e.g., prescribing medication or treatment, recommendations of over-the-counter medications, or application of medical treatment.

A “survey” or a “wave of surveys” refers to a comprehensive statistical survey on a physician population to identify a physician with a prescribed attribute. The survey involves an investigation of opinions or attitudes held by the physician population. Multiple waves of surveys allows the interconnection of hubs and spokes within the physician influence network. The surveys can be oral surveys that are recorded in a computing device, e.g., personal digital assistant, or recorded on paper by the sales representative. Alternatively the surveys can be written surveys that are provided to the physician population and can be returned by mail.

“Analysis of results” refers to collecting results of surveys of the physician population and determining the number of individuals within the population with certain prescribed attributes, for example, a physician influencer. The survey data is aggregated across all participating sales representatives and the calculations are performed to understand the estimated number of influencers that exist and the precision around the estimate. If the desired level of convergence and precision to identify physician influencers has not been achieved, a new set or the same set of sales representatives are selected, and a new set of targeted customers/physicians are randomly selected for the next wave of surveying. This mechanized process repeats until the desired level of precision is achieved.

This approach overcomes limitations of more traditional panel surveys of physicians and/or surveys that measure and describe physician attributes, but do not attempt to enumerate the number of physicians possessing a specific attribute within the total physician population. As the estimate and confidence interval begin to asymptotically converge to some pre-determined level of consistency and precision, the sampling can then be halted to maximize benefit versus cost. The method to estimate the expected number of physician influencers or physicians who are influenced provides a guide to when surveying should cease once a desired percentage of influencers have been identified and until the estimate of the number of physicians with the prescribed attribute achieves a predetermined level of statistical precision.

A “predetermined level of statistical precision” refers to, for example, the desired range of the 95% confidence interval around the estimate. See, for example, Table 1.

“Enumerating the number of physicians with a prescribed attribute” refers to utilizing the method of the present invention to ascertain the number of physicians with the prescribed attribute and/or to identify individual physicians with the prescribed attribute, e.g., wherein the attribute is one who influences other physicians.

A “medical expert” refers to a person with a great deal of knowledge about, or skill, training, or experience in the field of medicine. The medical expert can be a specialist in a medical field or can be a general practitioner. The medical expert can be, for example, a medical doctor, osteopathic doctor, nurse, physician's assistant, physical therapist, or pharmacist, who is an expert in a particular health care field.

A “respondent physician” or “respondent” refers to a physician or a health care professional who replies to a survey or questionnaire in a complete manner or who replies with enough information to identify physicians or health care professionals with a prescribed attribute, e.g., physician influencers within a physician population. The “respondent physician” has identified who the respondent considers an influential physician within the sphere of the respondent physician's contacts within a social and professional system. A “non-respondent physician” refers to a physician that does not respond to the survey or does not respond with sufficient information to identify physicians with a prescribed attribute, e.g., physician influencers within a physician population.

System for Identifying Physicians with a Prescribed Attribute

In another embodiment of the invention, a system for identifying physicians with a prescribed attribute within a physician population is described. The system comprises one or more computers connected to a network to input survey responses of the physician population, a server connected to the network to receive the survey responses from the one or more computers, wherein the one or more computers or the server analyze the survey responses using a population marking methodology, and the one or more computers or the server collate and analyze the survey responses of the physician population, and identify the physicians with a prescribed attribute. One or more waves of survey responses are inputted into the computer system and the one or more computers or the server collate and analyze the one or more waves of survey responses of the physician population, to identify and estimate the number of physicians with a prescribed attribute.

A system for implementing methods for identifying and estimating the number of physicians with a prescribed attribute within a physician population can use a computing device (e.g., personal digital assistant (PDA), a laptop computer, a tablet computer, a desktop computer linked to a computer network), a written survey, an oral survey, or a mail survey. In one embodiment, a computing device can be used by a pharmaceutical company with a field sales force (FSF) that allows the company to efficiently leverage the FSF to collect the physician influence network information and to receive results of the analysis. The survey methods and computing devices to implement the methods can be cost effective to administer and are comprehensive in sampling scope. In another embodiment, a written or oral survey or a mail survey can be used by a pharmaceutical company with a FSF or in addition to the FSF that allows the company to efficiently leverage the FSF and augment the FSF to collect the physician influence network information and to receive results of the analysis.

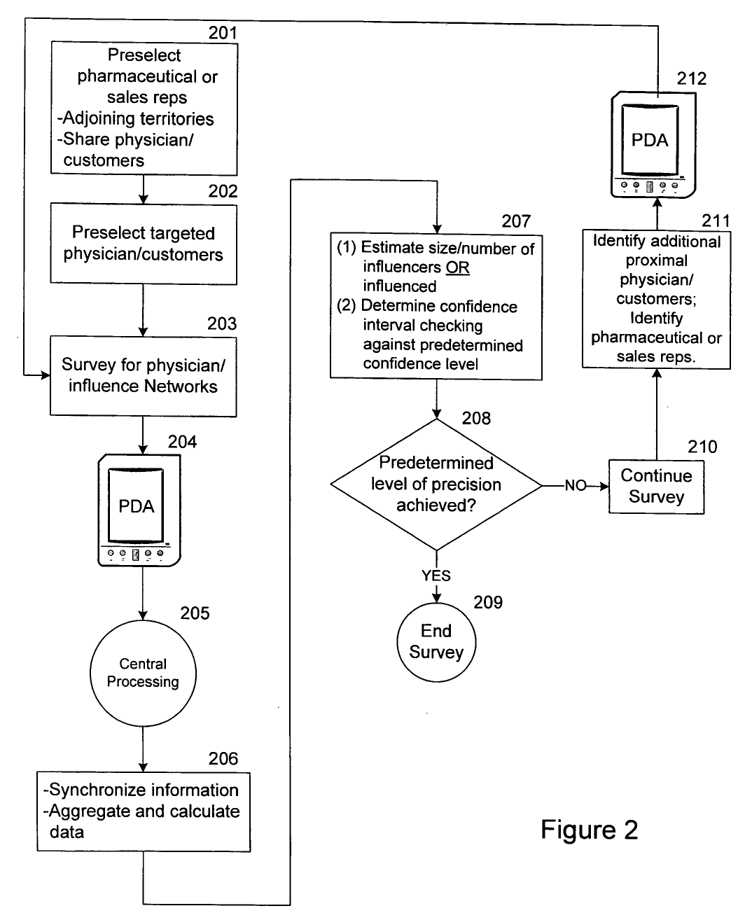

As shown in FIG. 2, a method and system for identifying physicians with a prescribed attribute within a physician population leverages the pharmaceutical company, or the field sales force representing the pharmaceutical company, and computing technology (e.g., handheld computer or PDA) to collect and record the information, alternatively, by collecting information by mail surveys. A pre-selected number of pharmaceutical representatives or sales representatives 201 ask a pre-selected sample of targeted physicians/customers about their influence networks 202, 203 and record the information on their PDA 204. The survey or questionnaire can ask a series of questions related to, for example, who a physician respondent would look to for therapeutic guidance as a medical expert; and/or who a physician respondent would look to for counsel on a case study basis as a trusted friend. This information is recorded and sent to central processing (CP) 205 each evening when the field sales force synchronizes information to send and receive their call and sample information 206. At CP the data is aggregated across all participating representatives, and the calculations are performed to understand the estimated number of influencers that exist and the precision around the estimate 206, 207. See, e.g., Example 1 and Table 1. If the desired level of convergence and precision has not been achieved, 208, a new set of targeted physicians/customers, and possibly, a new set of pharmaceutical representatives or sales representatives, is randomly selected for the next wave of surveying 210, 211, 212. The process utilizes handheld computing technology with or without a centralized server computer. The survey process repeats until the desired level of precision is achieved 209.

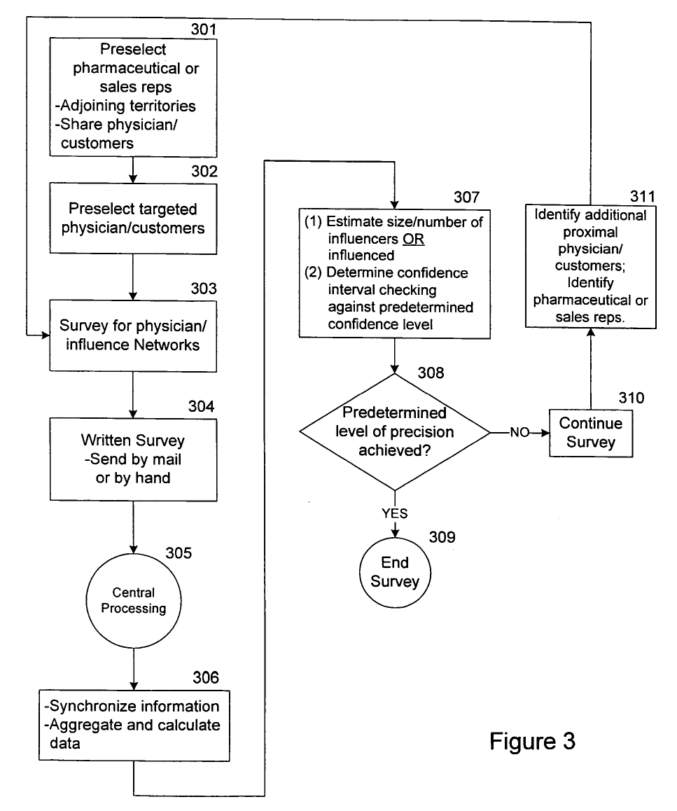

As shown in FIG. 3, a method and system for identifying physicians with a prescribed attribute within a physician population leverages the pharmaceutical company, or the field sales force representing the pharmaceutical company to collect and record the information by collecting information by oral or written surveys or by mail surveys. A pre-selected number of pharmaceutical representatives or sales representatives 301 ask a pre-selected sample of targeted physicians/customers about their influence networks 302, 303 and record the information on a written survey 304. Alternatively, a pre-selected sample of targeted physicians/customers are sent a mail survey to ask about their influence networks 302, 303 and are asked to record the information on the written survey 304. The survey or questionnaire can ask a series of questions related to, for example, who a physician respondent would look to for therapeutic guidance as a medical expert; and/or who a physician respondent would look to for counsel on a case study basis as a trusted friend. This information is recorded and sent to central processing (CP) 305 by return mail or by the sales representatives or when the field sales force synchronizes information to send and receive their call and sample information 306. At CP the data from written surveys or recorded oral surveys is aggregated across all participating representatives, and the calculations are performed to understand the estimated number of influencers that exist and the precision around the estimate 306, 307. See, e.g., Example 1 and Table 1. If the desired level of convergence and precision has not been achieved, 308, a new set of targeted physicians/customers and possibly, a new set of pharmaceutical representatives or sales representatives, is randomly selected for the next wave of surveying 310, 311, 312. The process utilizes oral surveys, written surveys, or mail surveys with or without a centralized server computer to collect the information. The survey process repeats until the desired level of precision is achieved 309.

With respect to identifying physicians within a physician influence network, physician with a prescribed attribute (i.e., a “marked” physician) refers to a physician with a quality or characteristic ascribed to the physician, wherein the influenced physician respects the quality or character of the influencing physician and is motivated to adopt the same. Moreover, the physician with a prescribed attribute can be, for example, an influencer physician, one who influences others within the physician population or an influenced physician, one who is influenced by others within the physician population. The physician with a prescribed attribute can be, for example, a physician who is a high prescriber, who writes frequent prescriptions for a pharmaceutical drug or biologic, or a physician who is a low prescriber or medium prescriber, who writes few or moderate numbers of prescriptions for a pharmaceutical drug or biologic. The physician with a prescribed attribute can also be a physician who influences managed care formularies or a physician who has an interest in participating in clinical drug research. The physician with a prescribed attribute can also be one who is considered by his/her peers and the medical community as providing a source of trusted information within the physician population, or one who is a source of therapeutic guidance as a medical expert within the physician population.

Identifying the physicians with a prescribed attribute within the physician population occurs through one or more waves of surveying the physician population. In subsequent waves of surveying the physician population, the number of physicians with a prescribed attribute newly identified continues until a confidence level is reached at a predetermined level of statistical precision.

Physician Influence Network in the Context of a Social and Professional System

A physician influence network can be understood in the context of a social and professional system which is defined as a set of interrelated units that are engaged in joint problem solving to accomplish a common goal. The structure of this system, that is, the patterned arrangements of its units, is a major factor in the success and rate of diffusion. Identification of physicians who influence other physicians within a network can benefit from an understanding of the attributes of innovation which are strong indicators of the potential for adoption of the innovation. The attributes of innovation can lead to an understanding of opinion leadership within a social and professional system. An understanding of the attributes of innovation is useful to develop methods for identifying physician with a prescribed attribute within a physician population, for example, a method for identifying physician influence networks. Rates of diffusion and adoption depend to a large degree on how certain characteristics of the innovation interact with various aspects of the targeted social and professional system. See, for example, Hawks, The Diffusion of Innovation: an Executive Summary, Comsort, Baltimore, Md.

The characteristics that can have an effect on diffusion and adoption of innovation have been divided into five categories:
(1) Relative advantage is the extent to which the innovation is perceived as better than that which it would replace;
(2) Compatibility is the perceived consistency of the innovation with the established values, needs, and experiences of potential adopters;
(3) Complexity refers to the extent to which an innovation is difficult to understand; the greater the difficulty, the more reluctant potential adopters will be to embrace the change;
(4) Trialability is the extent with which an innovation can be experienced before a commitment to full implementation is made; and
(5) Observability is the degree to which the benefits of the proposed change will be visible.

Methods and systems, as described herein, can use these factors to develop techniques and to design surveys to identify physicians with a prescribed attribute (e.g., physician influencers) within a physician population.

Population Marking to Identify Physicians with a Prescribed Attribute

A method for identifying physicians with a prescribed attribute within a physician population can apply methods similar to population marking, or “mark and recapture.” To identify (i.e., mark) physicians with a prescribed attribute within a physician population, the physician population is surveyed in one or more waves of surveys, and calculations are performed to determine a proportion of the population with specific attributes (e.g., a physician influencer or a physician who is influenced). Once a wave of surveys find already-identified physician influencers or physicians who are influenced that were identified in prior survey waves, one can estimate the size of the influencer population, and one can estimate the confidence interval around the estimate. With each successive survey wave a more refined estimate can be developed. The multiple waves of surveys are analyzed using a population marking methodology (e.g., a “mark and recapture” analysis). As the estimate and confidence interval begin to asymptotically converge to some pre-determined level of consistency and precision, the sampling can then be halted to maximize benefit versus cost.

A population marking methodology, or “mark and recapture,” refers to statistical methods that can be applied to the problem of surveying and analyzing a physician population, and estimating the number of physicians with a prescribed attribute within the physician population. As described above, mark and recapture methods for estimating a population size can be, for example, the Petersen method, the Schnabel method, the Schumacher-Eschmeyer method, or other methods. See, for example, Krebs, Ecology, Harper and Row, N.Y., 694, 1972; Krebs, Ecological Methodology, Benjamin/Cummings, Menlo Park, Calif., 654, 1999; Ricker, Bull. Fish. Res. Board Canada 191: 382 and 75-104, 1975

The Petersen method is a mark-recapture method for estimating population size, N₀. For the Petersen method, all animals in a single sample are given a mark or tag and returned to the environment alive. The Schnabel method extends the Petersen method to more than 1 resample, relying upon the same theory as the Petersen method. N₀ is estimated by the ratio of the number of marked animals released into the population to the estimated proportion of marks in the population. The Schnabel estimate of N₀ is a weighted average of s individual Petersen estimates. The Schumacher-Eschmeyer method uses the exact same data and has the same assumptions as the Schnabel method. Other multiple mark and recapture methods can also be applied depending on the population and sampling conditions. These methods include, but are not limited to, the Schumacher-Eschmeyer method and the Jolly-Seber method.

Several methods can be used for determining confidence intervals (CT). Confidence intervals provide an estimate of the variability (precision) of the estimate. A confidence interval refers to the probability that a measurement will fall within a given closed interval [a, b]. Usually the confidence interval is symmetrically placed about the mean. A confidence interval of the estimate of the physicians with a prescribed attribute within the physician population refers to the probability that the measurement of the number of individuals with a specific attribute within the population will fall within a given closed interval.

Distributed Computing Survey Array

The application of the method to a specific type of problem is integrated into a distributed computing survey array that can be used on a machine or device such as a computer or PDA, or can be used with a mailed survey and response.

A system for identifying physicians with a prescribed attribute within a physician population is provided comprising one or more computers connected to a network to input survey results of the physician population, a server connected to the network to receive the survey results from the one or more computers, and the one or more computers or the server analyze the survey results to determine a population marking methodology. The one or more computers or the server further collate the survey results and analyze one or more surveys of the physician population, and identify physicians with a prescribed attribute within the physician population. The one or more computers can be hand-held devices, for example, personal digital assistant (PDA). Analysis and dissemination of the survey results can occur on one or more computers (or PDAs) on the network or can be collected, analyzed and disseminated from a server computer on the network.

Identification of Physician Influencers Within a Physician Population

To identify physician with a prescribed attribute within a physician population, the physician population is surveyed, survey responses of physicians within the physician population are analyzed using a population marking methodology, and physicians with a prescribed attribute within the physician population are estimated. Calculations are performed using a population marking methodology (e.g., a mark and recapture method) to determine a proportion of the population with specific attributes (e.g., a physician influencer or a physician who is influenced). Once a wave of surveys finds already identified influencers that were found in prior waves, one can estimate the size of the influencer population and the confidence interval around the estimate. With each successive survey wave a more refined estimate can be developed. As the estimate and confidence interval begin to asymptotically converge to some pre-determined level of consistency and precision, the sampling can then be halted to maximize benefit versus cost.

The means of applying the statistical method is to leverage the field sales force (FSF) and computing technology (e.g., handheld computer or PDA) to collect and record the information, in addition to collecting information by mail surveys. A pre-selected number of sales representatives ask a pre-selected sample of targeted customers/physicians about their influence networks and record the information on their PDA. The questionnaire can ask a series of questions related to: (1) Who do you look to for therapeutic guidance as a medical expert? (2) Who do you look to for counsel on a case study basis as a medical expert and/or trusted friend? (3) Who do you look to as an expert in the field? This information is recorded in the PDA and sent to central processing (CP) when the field sales force synchronizes information to send and receive their call and sample information, or collected by mail survey, or sent by any means of communication. At CP, the data is aggregated across all participating representatives, and the calculations are performed to understand the estimated number of influencers that exist and the precision around the estimate. If the desired level of convergence and precision has not been achieved, a new set of sales representatives and targeted customers/physicians within the physician population are randomly selected for the next wave of surveying. The process utilizes hand held computing technology with or without a centralized server computer. The survey process repeats until the desired level of precision was achieved.

### EXAMPLE 1

### Prophetic

An exemplary calculation of the estimated number of physicians with a prescribed attribute (e.g., physician influencers) within a physician population is shown in Table 1. In this example, survey waves are performed six times. After six survey waves, an acceptable level of statistical precision is achieved as determined by the 95% range. In Table 1, the number of influencers identified and the number of new influencers identified increase from wave I to wave 2, and then decrease from waves 2 through 6. The number of influencers re-identified increase from zero in waves 1 to 3, up to three in wave 6.

Performing calculations using the Schnabel method, the Schnabel estimate of the number of physician influencers within the physician population can be estimated. Columns 1 to 5 contain the products needed for the Schnabel estimate.

An approximation to the maximum likelihood estimate of N from multiple censuses is given by the following formula. See, for example, Ricker, Bull. Fish. Res. Board. Canada 191: 382 and 96, 1975, incorporated herein by reference in its entirety.

$$N = \frac{\sum ( {C}_{t} {M}_{t} )}{\sum {R}_{t}} = \frac{\sum ( {C}_{t} {M}_{t} )}{R} = \frac{1918}{6} = 320 \qquad ( eqn . 6 )$$

Using the Schnabel estimate, the exemplary embodiment shown in Table 1 estimates the number of physician influencers within the physician population is 320, after six survey waves with a 95% confidence range from 89 to 530.

To calculate this final number of physician influencers within the physician population, successive waves of surveys are performed, and calculations are performed at the end of each survey wave. In a first of six survey waves of the exemplary embodiment, 10 physician influencers are identified. The cumulative influencers at large are 10, and CₜMₜ equals 100.

In a second survey wave, 20 physician influencers are identified. Of these 20, all are new influencers not identified in the first survey wave. The cumulative influencers at large are 30, and CₜMₜ equals 600.

In a third survey wave, 15 physician influencers are identified. Of these 15, all are new influencers not identified in the first or second survey waves. The cumulative influencers at large are 1, and CₜMₜ equals 675.

In a fourth survey wave, six physician influencers are identified. Of these six, four are new influencers not identified in the three previous survey waves. The cumulative influencers at large are 49, and CₜMₜ equals 294. As a result of the fourth survey wave, the estimated number of physician influencers in the population using the Schnabel estimate is 417, with a 95% confidence range from 162 to 5825. Because this range is not an acceptable level of statistical precision, a fifth survey wave is performed.

In a fifth survey wave, one physician influencer is identified. This one influencer was previously identified in one of the four previous survey waves. Zero new influencers are identified. The cumulative influencers at large remains at 49, and CₜMₜ equals 49. As a result of the fourth survey wave, the estimated number of physician influencers in the population using the Schnabel estimate is 344, with a 95% confidence range from 132 to 1942. Because this range is not an acceptable level of statistical precision, a sixth survey wave is performed.

In a sixth survey wave, four physician influencers are identified. Of these four, one is a new influencers not identified in the five previous survey waves. The cumulative influencers at large are 50, and CₜMₜ equals 200. As a result of the sixth survey wave, the estimated number of physician influencers in the population using the Schnabel estimate is 320, with a 95% confidence range from 89 to 530. This 95% range is an acceptable level of statistical precision so no further surveys need to be performed. The estimated number of physician influencers in the population is 320 at a 95% confidence range.

This approach overcomes limitations of more traditional panel surveys of physicians and/or surveys that measure and describe physician attributes, but do not attempt to enumerate the number of physicians possessing a specific attribute within the total physician population. As the estimate and confidence interval begin to asymptotically converge to some pre-determined level of consistency and precision, the sampling can then be halted to maximize benefit versus cost. The method to estimate the expected number of physician influencers or physicians who are influenced provides a guide to when surveying should cease once a desired percentage of influencers have been identified and until the estimate of the number of physicians with the prescribed attribute achieves a predetermined level of statistical precision.

The inventive method for identifying physicians with certain prescribed attributes can further comprise surveying the physician population in two or more waves of surveys, and analyzing each wave of survey responses. This method can be repeated as described above until the estimate of the number of physicians with the prescribed attribute achieves a predetermined level of statistical precision.

The disclosures of each patent, patent application and publication cited or described in this document are hereby incorporated herein by reference, in their entirety.

Those skilled in the art will appreciate that numerous changes and modifications can be made to the embodiments of the invention and that such changes and modifications can be made without departing from the spirit of the invention. A method for identifying physicians with a prescribed attribute within a physician population is described herein. Physicians with any desired prescribed attribute can be identified by providing a survey method that asks a respondent to identify the physician with a prescribed attribute. It is, therefore, intended that the appended claims cover all such equivalent variations as fall within the true spirit and scope of the invention.

TABLE 1

| | 1 | 2 | | 4 | | | |
|---|---|---|---|---|---|---|---|
| | Number of | Number of | 3 | Cumulative | | | |
| | Influencers | Influencers | Number of | Influencers | 5 | Estimated # of | |
| Sample | Identified | Re-Identified | New Influencers | at Large | 1 × 4 | Influencers in | |
| Wave # | Cₜ | Rₜ | Identified | Mₜ | CₜMₜ | Population* | 95% Range** |
| 1 | 10 | 0 | 10 | 0 | 0 | | |
| 2 | 20 | 0 | 20 | 10 | 200 | | |
| 3 | 15 | 0 | 15 | 30 | 10 | | |
| 4 | 6 | 2 | 4 | 1 | 270 | 460 | 162, 5825 |
| 5 | 1 | 1 | 0 | 49 | 49 | 323 | 132, 1942 |
| 6 | 4 | 3 | 1 | 49 | 196 | 194 | 89, 530 |
| Total | 56 | 6 | 50 | 183 | 1165 | | |

*Calculation according to Schnabel method (Ricker, 1972, Bull. Fish. Res. Board. Canada, 191: 96; eqn. 3.15).
**Using Poisson estimate and table in Appendix II of Ricker, 1972.

1. A method comprising:
(a) surveying a health care professional population and obtaining responses from said health care professional population,
(b) identifying health care professionals with a prescribed attribute using results of the survey, and
(c) analyzing said identified health care professionals with said prescribed attribute using a population marking methodology to determine size of a population having said prescribed attribute with a predetermined level of precision.

2. The method of claim 1, further comprising:
repeating steps a, b, and c until a predetermined level of statistical precision is achieved in estimating the size of said population having said prescribed attribute.

3. The method of claim 2, wherein the repeated surveying steps comprise surveying a new or non-respondent health care professional population.

4. The method of claim 1, further comprising enumerating the number of health care professionals who possess said prescribed attribute.

5. The method of claim 1, wherein said health care professionals with said prescribed attribute are health care professionals who influence others.

6. The method of claim 1, wherein said health care professionals with said prescribed attribute are health care professionals who are influenced by others.

7. The method of claim 1, wherein said health care professionals with said prescribed attribute are a source of trusted information.

8. The method of claim 1, wherein said health care professional is a medical doctor, osteopathic doctor, nurse, physician's assistant, physical therapist, or pharmacist.

9. The method of claim 1, wherein surveying further comprises asking respondents to identify health care professionals who influence their health care decision-making.

10. The method of claim 1, wherein surveying further comprises asking respondents to identify health care professionals who influence their medical decision-making regarding recommendation of prescription drugs, prescription treatments, non-prescription drugs, non-prescription treatments, or therapeutic procedures.

11. The method of claim 1, wherein health care professionals with said prescribed attribute are a source of therapeutic guidance as experts in their health care field.

12. The method of claim 2, further comprising determining a confidence interval of the estimate of health care professionals with said prescribed attribute.

13. The method of claim 12, further comprising comparing the confidence interval to a predetermined confidence interval.

14. The method of claim 13, further comprising repeating the survey if the confidence interval is greater than the predetermined confidence interval.

15. The method of claim 13, further comprising ending the survey if the confidence interval is equal to or less than the predetermined confidence interval.

16. The method of claim 1, wherein the step of analyzing results involves the use of a computing device.

17. The method of claim 1, wherein the step of surveying said population involves the use of written surveys, oral surveys, or mail surveys.

18. The method of claim 17, wherein the step of analyzing results involves the analysis of written surveys, oral surveys, or mail surveys.

19. The method of claim 18, wherein the step of analyzing results involves the use of a computing device.

20. A method comprising:
(a) surveying a physician population and obtaining responses from said physician population,
(b) identifying physicians with a prescribed attribute using results of the survey, and
(c) analyzing said identified physicians with said prescribed attribute using a population marking methodology to determine size of a population having said prescribed attribute with a predetermined level of precision.

21. The method of claim 1, further comprising:
repeating steps a, b, and c until a predetermined level of statistical precision is achieved in estimating the size of said population having said prescribed attribute.

22. The method of claim 21, wherein the repeated surveying steps comprise surveying a new or non-respondent physician population.

23. The method of claim 20, further comprising enumerating the number of physicians who possess said prescribed attribute.

24. The method of claim 20, wherein physicians with said prescribed attribute are physicians who influence others.

25. The method of claim 20, wherein physicians with said prescribed attribute are physicians who are influenced by others.

26. The method of claim 20, wherein physicians with said prescribed attribute are a source of trusted information.

27. The method of claim 20, wherein physicians with said prescribed attribute are a source of therapeutic guidance as a medical expert.

28. The method of claim 20, wherein physicians with said prescribed attribute are physicians who influence managed care formularies.

29. The method of claim 20, wherein physicians with said prescribed attribute are physicians who have an interest in participating in a clinical drug research.

30. The method of claim 20, wherein surveying further comprises asking respondents to identify physicians who influence their medical decision-making.

31. The method of claim 30, wherein surveying further comprises asking respondents to identify physicians who influence their medical decision-making regarding recommendation or prescription of drugs.

32. The method of claim 30, wherein surveying further comprises asking respondents to identify physicians who influence their medical decision-making regarding recommendation or prescription of biologics.

33. The method of claim 30, wherein surveying further comprises asking respondents to identify physicians who influence their medical decision-making regarding recommendation of a therapeutic procedure.

34. The method of claim 21, further comprising determining a confidence interval of the estimate of physicians with said prescribed attribute.

35. The method of claim 34, further comprising comparing the confidence interval to a predetermined confidence interval.

36. The method of claim 35, further comprising repeating the survey if the confidence interval is greater than the predetermined confidence interval.

37. The method of claim 35, further comprising ending the survey if the confidence interval is equal to or less than the predetermined confidence interval.

38. The method of claim 20, wherein the step of analyzing results involves the use of a computing device.

39. The method of claim 20, wherein the step of surveying said population involves the use of written surveys, oral surveys, or mail surveys.

40. The method of claim 39, wherein the step of analyzing results involves the analysis of written surveys, oral surveys, or mail surveys.

41. The method of claim 40, wherein the step of analyzing results involves the use of a computing device.

42. A system comprising:
a database of survey responses from a physician population,
a computer connected to the database and configured to receive and analyze said survey responses,
wherein said computer is programmed to identify physicians with a prescribed attribute by survey responses and to analyze said identified physicians with said prescribed attribute using a population marking methodology to determine size of a population having said prescribed attribute with a predetermined level of precision.

43. The system of claim 42, further comprising:
additional survey responses from the physician population added to said database,
said computer receives and analyzes said additional survey responses to identify physicians with said prescribed attribute using a population marking methodology, until a predetermined level of statistical precision in estimating the size of the population having said prescribed attribute is achieved.

44. The system of claim 43 wherein said additional survey responses are survey responses from a new or non-respondent physician population.

45. The system of claim 42, wherein said computer enumerates the number of physicians with said prescribed attribute.

46. The system of claim 43, wherein said computer analyzes said survey results to determine a confidence interval of the estimate of physicians with said prescribed attribute.

47. The system of claim 46, wherein said computer analyzes said survey results to compare the confidence interval to a predetermined confidence interval.

48. The system of claim 47, wherein said computer sends instructions to repeat said survey if the confidence interval is greater than the predetermined confidence interval.

49. The system of claim 47, wherein said computer sends instructions to end said survey if the confidence interval is equal to or less than the predetermined confidence interval.

50. A method comprising:
(a) surveying a physician population to determine physicians who influence other physicians,
(b) identifying physicians who influence other physicians using results of the survey,
(c) analyzing said identified physicians using a population marking methodology, and
(d) repeating steps a, b, and c until a predetermined level of statistical precision is achieved in estimating the size of the population having said prescribed attribute.

51. The method of claim 50, wherein the repeated surveying steps comprise surveying a new or non-respondent physician population.

52. The method of claim 50, further comprising enumerating the number of physicians who influence other physicians.

53. The method of claim 50, wherein said physicians who influence other physicians are ones who are a source of trusted information.

54. The method of claim 50, wherein said physicians who influence other physicians are ones who are a source of therapeutic guidance as a medical expert.

55. The method of claim 50, wherein said physicians who influence other physicians are ones who are physicians who influence managed care formularies.

56. The method of claim 50, wherein said physicians who influence other physicians are ones who are physicians who have an interest in participating in clinical drug research.

57. The method of claim 50, wherein surveying further comprises asking respondents to identify physicians who influence their medical decision-making.

58. The method of claim 50, wherein surveying further comprises asking respondents to identify physicians who influence their medical decision-making.

59. The method of claim 58, wherein surveying further comprises asking respondents to identify physicians who influence their medical decision-making regarding recommendation or prescription of drugs.

60. The method of claim 58, wherein surveying further comprises asking respondents to identify physicians who influence their medical decision-making regarding recommendation or prescription of biologics.

61. The method of claim 58, wherein surveying further comprises asking respondents to identify physicians who influence their medical decision-making regarding recommendation of a therapeutic procedure.

62. The method of claim 50, further comprising determining a confidence interval of the estimate of physicians with said prescribed attribute.

63. The method of claim 62, further comprising comparing the confidence interval to a predetermined confidence interval.

64. The method of claim 60, further comprising repeating the survey if the confidence interval is greater than the predetermined confidence interval.

65. The method of claim 60, further comprising ending the survey if the confidence interval is equal to or less than the predetermined confidence interval.

66. The method of claim 50, wherein the step of analyzing results involves the use of a computing device.
